(19) United States
(12) Patent Application Publication
(10) Pub. No.: US 2009/0313656 A1
(43) Pub. Date: Dec. 17, 2009

(54) METHOD FOR UPDATING ELECTRONIC PROGRAMMING GUIDE (EPG) OR BROADCAST RECEIVING APPARATUS AND BROADCAST RECEIVING APPARATUS USING THE SAME

(75) Inventor: Tae Ri LEE, Yongi-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/273,199

(22) Filed: Nov. 18, 2008

(30) Foreign Application Priority Data
Jun. 12, 2008 (KR) 10-2008-0055285

(51) Int. Cl. H04N 5/445

(52) U.S. Cl. 725/50

(57) ABSTRACT

A method for updating an electronic programming guide (EPG) or a broadcast receiving apparatus, and a broadcast receiving apparatus using the same are provided. The method for updating the EPG includes setting a time point within a time period when the broadcast receiving apparatus is not operating to be an update time to update the EPG; and updating EPG information at the update time.

### CROSS-REFERENCE TO RELATED APPLICATIONS

This application claims priority from Korean Patent Application No. 10-2008-0055285, filed Jun. 12, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to updating an electronic programming guide (EPG), and more particularly, to updating EPG information received via a broadcast signal or a communication network.

2. Description of the Related Art

Televisions (TVs) provide functions for displaying electronic programming guide (EPG) information. Users may view EPG information using a TV, and may check programs scheduled to be broadcast on specific channels and at specific times.

The EPG information may be displayed on a screen when a user presses a button to display an EPG window using a remote controller. However, when a user presses an EPG button using a remote controller, EPG information is displayed on the screen after a predetermined time has elapsed because the TV takes the time to receive and update EPG information.

As a result of digital Internet Protocol Television (IPTV) becoming widespread, there are many more channels and much more EPG information is available. Therefore, a longer time is required to update EPG information.

If there is a waiting time due to EPG updating, a user experiences inconvenience. Accordingly, methods and apparatuses are needed for updating an EPG in a efficient and easy way.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a method for updating electronic programming guide (EPG) information while a user is not viewing a TV, in which a predetermined time when a broadcast receiving apparatus is not operating is determined to be the time to update the EPG, and a broadcast receiving apparatus using the same.

According to an exemplary aspect of the present invention, there is provided a method for updating an electronic programming guide (EPG) of a broadcast receiving apparatus, the method including setting a time point within a time period while the broadcast receiving apparatus is not operating to be a start time to start updating the EPG; and starting updating EPG information at the start update time.

The setting may include storing operating information of the broadcast receiving apparatus; and determining a time period for which the broadcast receiving apparatus does not operate based on the operating information of the broadcast receiving apparatus.

The setting may include calculating a representative operating time of the broadcast receiving apparatus based on the operating information; and setting a time a predetermined time interval earlier than the representative operating time to be the time to update an EPG.

The calculating may include extracting turn-on times for each respective day from the operating information; and setting the earliest turn-on time of turn-on times for each respective day to be the representative operating time using the turn-on time for the respective days.

The calculating may include extracting turn-on times for each respective day from the operating information; and setting an average turn-on time of turn-on times for the respective days to be the representative operating time using the turn-on times for the respective days.

The predetermined time interval may be longer than the time period to update the EPG information.

The operating information may include turn-on times of the broadcast receiving apparatus for each respective day of the week or day of the month.

The updating may include updating the EPG information after the broadcast receiving apparatus is turned on, if a current time corresponds to the time to update an EPG, and if the broadcast receiving apparatus is in a standby state.

The updating may include changing the broadcast receiving apparatus to a standby state after the EPG information is updated.

The updating may include updating the EPG information at a set time to update an EPG, if a user sets the time to update the EPG.

The time period during which the broadcast receiving apparatus does not operate may include a time period during which the broadcast receiving apparatus is in a standby state.

According to an exemplary aspect of the present invention, there is provided a broadcast receiving apparatus, including a storage unit which stores electronic programming guide (EPG) information; and a control unit which sets a time point within a time period when the broadcast receiving apparatus is not operating to be a start update time to start updating an EPG, and starts updating the EPG information at the start update time.

The storage may store operating information of the broadcast receiving apparatus; and the control unit may set a time period during which the broadcast receiving apparatus is not operating based on the operating information of the broadcast receiving apparatus.

The control unit may calculate a representative operating time of the broadcast receiving apparatus based on the operating information, and set a time a predetermined time interval earlier than the representative operating time to be the time to update an EPG.

The control unit may extract turn-on times for each respective day from the operating information, and set the earliest turn-on time of turn-on times for each respective day to be the representative operating time using the turn-on times for the respective days.

The control unit may extract turn-on times for each respective day from the operating information, and determine an average turn-on time of turn-on times for the respective days to be the representative operating time using the turn-on times for the respective days.

The predetermined time interval may be longer than the time period to update the EPG information.

The operating information may include turn-on times of the broadcast receiving apparatus for each respective day of the week or day of the month.

If a current time corresponds to the time to update the EPG, and if the broadcast receiving apparatus is in a standby state, the control unit may turn on the broadcast receiving apparatus, and update the EPG information.

The control unit may change the broadcast receiving apparatus to a standby state after the EPG information is updated.

If a user sets a time to update the EPG, the control unit may update the EPG information at the time set to update the EPG.

The time period during which the broadcast receiving apparatus does not operate may comprise a time period during which the broadcast receiving apparatus is in a standby state.

According to an exemplary aspect of the present invention, there is provided a method for updating a broadcast receiving apparatus, including storing operating information of the broadcast receiving apparatus; setting an update time based on the operating information of the broadcast receiving apparatus; and updating data stored in the broadcast receiving apparatus at the update time.

According to an exemplary aspect of the present invention, there is provided a broadcast receiving apparatus, including a storage unit which stores operating information and predetermined data of the broadcast receiving apparatus; and a control unit which sets an update time to update data based on the operating information of the broadcast receiving apparatus, and updates the data stored in the storage unit at the update time.

### BRIEF DESCRIPTION OF THE DRAWINGS

The above and/or other aspects of the present invention will be more apparent by describing exemplary embodiments of the present invention with reference to the accompanying drawings, in which:

FIG. 1 is a block diagram illustrating a broadcast apparatus according to an exemplary embodiment of the present invention;

FIG. 2 is a flowchart for determining the time to update an EPG according to an exemplary embodiment of the present invention;

FIG. 3 is a flowchart for updating an EPG according to an exemplary embodiment of the present invention;

FIG. 4 is a table showing the time to update an EPG by setting the earliest turn-on time to be a representative operating time according to an exemplary embodiment of the present invention; and

FIG. 5 is a table showing the time to update an EPG by setting the average turn-on time to be a representative operating time according to another exemplary embodiment of the present invention.

### DETAILED DESCRIPTION OF EXEMPLARY EMBODIMENTS

Exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

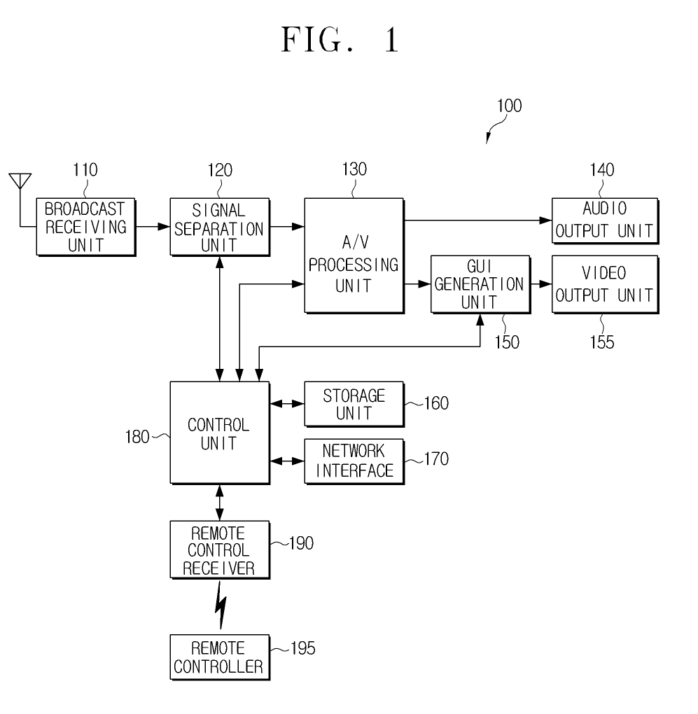

FIG. 1 is a block diagram illustrating a broadcast apparatus 100 such as a television (TV) according to an exemplary embodiment of the present invention. Referring to FIG. 1, a TV may comprise a broadcast receiving unit 110, a signal separation unit 120, an audio/video (A/V) processing unit 130, an audio output unit 140, a graphical user interface (GUI) generation unit 150, a video output unit 155, a storage unit 160, a network interface 170, a control unit 180, a remote control receiver 190, and a remote controller 195.

The broadcast receiving unit 110 receives broadcasting from a broadcast station or satellite over wire or wirelessly, and tunes to the received broadcasting. A broadcast signal received by the broadcast receiving unit 110 may be an additional information signal, and may include a Program and System Information Protocol (PSIP) information. The PSIP information may include electronic programming guide (EPG) information.

The signal separation unit 120 separates a broadcast signal into a video signal, an audio signal, and additional data signal. The signal separation unit 120 transmits audio and video signals to the A/V processing unit 130, and transmits the additional data signal to the control unit 180.

The A/V processing unit 130 processes signals output from the broadcast receiving unit 110 and the control unit 180 using video decoding, video scaling, and audio decoding. The A/V processing unit 130 outputs a video signal to the GUI generation unit 150, and outputs an audio signal to the audio output unit 140.

If the received video and audio signals are stored in the storage unit 160, the A/V processing unit 130 outputs the video and audio signals in a compressed format to the storage unit 160.

The audio output unit 140 outputs audio output from the A/V processing unit 130 via a speaker.

The GUI generation unit 150 generates a GUI to be provided to a user. The GUI generation unit 150 combines the generated GUI with the video output from the A/V processing unit 130. The GUI generation unit 150 generates a GUI regarding an EPG using the received EPG information.

The video output unit 150 displays the video output from the A/V processing unit 130 on a display, or outputs the video to an external device such as an external display connected through an external output terminal.

The storage unit 160 stores recorded files having the received broadcast programs. The storage unit 160 stores operating information of the TV and EPG information. The storage unit 160 may be implemented as a hard disc drive (HDD) or a nonvolatile memory.

The operating information of the TV includes the date, day, and time at which the operating states of the TV is changed, and information regarding the operating states. For example, if a user turns on the TV at 3 pm on Monday, Jul. 2, 2008, and turns off the TV at 8 pm, the operating information records “3 pm, Monday, Jul. 2, 2008, turn on,” and “8 pm, Monday, Jul. 2, 2008, turn off.” The operating information records the operating states changed according to the time, and stores collected information in a database. The operating states may include information on when the TV is turned on, put on stand by, turned off, receives EPG update, or the like.

The network interface 170 is used as a path for communication connecting the TV to an internet The TV receives EPG information or multimedia content from the internet through the network interface 170. The TV is connected to the internet via the network interface 170, so a user may use an Internet Protocol Television (IPTV).

The remote control receiver 190 receives commands input by a user using the remote controller 195, and transmits the input commands to the control unit 180.

The control unit 180 recognizes the user commands received from the remote controller 195, and controls overall operations of the TV according to the user command.

The control unit 180 determines a time point at which the TV is not operating to be a start update time to start updating the EPG. The time at which the TV is not operating represents the time when a user is not viewing the TV. For example, the time at which the TV is not operating includes the time when the TV is in a standby state.

Specifically, the control unit 180 determines the time when the TV is not operating using the operating information of the TV, determines the time to update the EPG, and updates the EPG information stored in the storage unit 160 based on the received EPG information at the determined EPG update time. The control unit 180 may determine that the time when the TV is not operating is earlier than a representative operating time explained below since the representative operating time refers to the time of day when a user is first operating the TV.

The operating information represents information in which the operating states are recorded, for example the date, day, time at which the operating states of the TV are changed. The operating states of the TV may change in various situations, and the operating information may be, for example, the date, day, and time at which the TV is turned on.

The control unit 180 may determine the representative operating time using the operating information of the TV to determine the time to update the EPG. The representative operating time represents the time of day at which the TV is first operated, for example, on a particular day of a week or a particular day of a month. The representative operating time may be different for each day of the week, and, thus, may include any of seven representative operating times for Sunday through Saturday, or may be any of thirty-one representative operating times for each day of the month.

For example, the representative operating time may be the earliest time among the turn-on times of the corresponding day of the week or of the month. The control unit 180 updates the EPG information at a time earlier than the time when a user turns on the TV, therefore, the EPG is updated before the user turns on the TV.

As another example, the average operating time of the turn-on times of the corresponding day of the week or of the month may be the representative operating time. In this example, the control unit 180 updates the EPG at the average time of the times at which a user turns on the TV.

The control unit 180 determines the time point for starting the update at a predetermined time interval earlier than the representative operating time to be the time to update an EPG. In doing so, the control unit 180 updates EPG information in advance before the user turns on the TV, or inputs a command to check the EPG information. The predetermined time interval is longer than the time period required to update the EPG information.

If the TV is in a standby state at the time of updating the EPG, the control unit 180 turns the TV on, thereby changing the TV to a turn-on state, and updates EPG information. In the standby state, a plug of the TV is inserted in a power socket, but the TV does not operate. In the standby state, since only a sub control unit of the control unit 180 operates, the TV operates in a limited manner and may be turned on to update the EPG information.

The control unit 180 changes the TV to the standby state after updating the EPG.

If the TV is in a turn-on state at the time of updating the EPG, the control unit 180 updates the EPG information.

If a user sets the start update time to update an EPG, the control unit 180 updates EPG information at the time set by the user. The control unit 180 may update the EPG information twice at the time set by the user and the time determined by the above process.

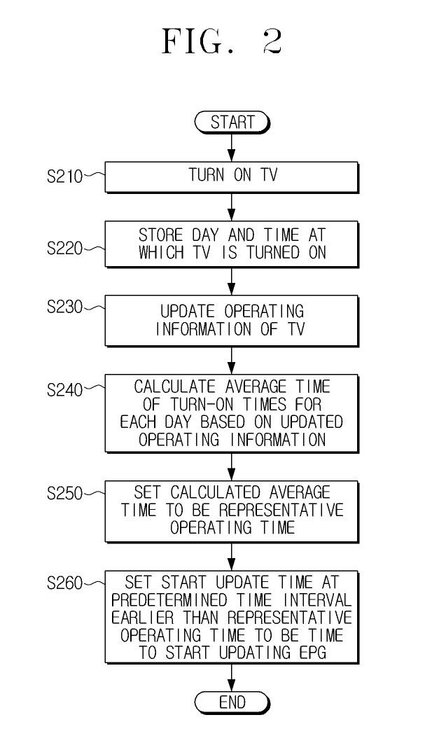

The process of determining the time to update an EPG is explained in detail with reference to FIG. 2. FIG. 2 is a flowchart provided to explain the process of determining the time to update an EPG according to an exemplary embodiment of the present invention.

If the TV is turned on (S210), the TV stores the date, day, and time at which the TV is turned on (S220). If operating states are changed, the TV stores the corresponding date, day, and time together with information regarding the operating states, and updates operating information (S230).

Based on the updated operating information, the TV extracts the times at which the TV is turned on for each day, and calculates an average time of the turn-on times for the days (S240). The TV sets the calculated average time to be a representative operating time (S250).

The TV may set the earliest time among the turn-on times of the corresponding days to be the representative operating time.

The TV determines the start update time point at the predetermined time interval earlier than the representative operating time to be the time to start updating the EPG (S260). The predetermined time interval is set to be longer than the time period required to update the EPG, and thus the EPG is completely updated before the TV is turned on.

The time to update the EPG is set to be the time prior to the time at which a user turns on the TV. That is, the time to update the EPG is determined to be a predetermined time point within the time period when the TV is not operating.

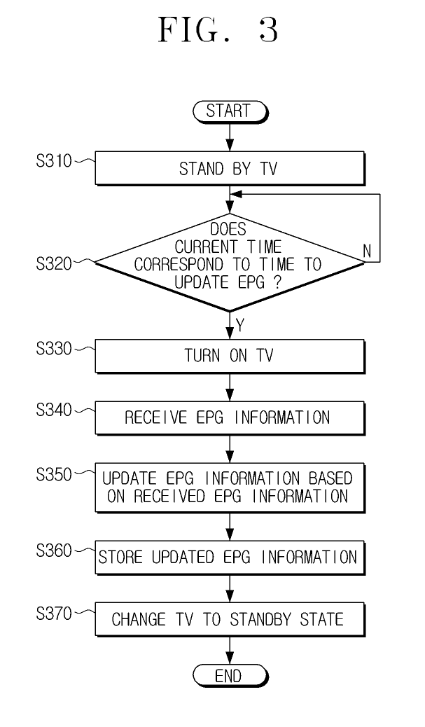

The method for updating the EPG information when the TV is in a standby state is explained with reference to FIG. 3. FIG. 3 is a flowchart provided to explain the process of updating an EPG according to an exemplary embodiment of the present invention.

While the TV is in the standby state (S310), the TV determines whether the current time corresponds to the time to update the EPG (S320). The TV checks whether the current time reaches the time to update an EPG even while the user is not viewing the TV.

If the current time corresponds to the time to update the EPG (S320), the TV is turned on, that is, changed to a turned-on state (S330). The turned-on state results from a Micom being activated when the TV is turned off.

The control unit 180 may include a main Micom and a sub Micom. Only the sub Micom is activated in the standby state. The sub Micom performs simple functions such as the operation of receiving a signal from the remote controller or the operation of determining the time to update an EPG.

The main Micom controls overall operations of the TV, so the TV performs all of the operations when the main Micom is activated.

After the TV is turned on, the TV receives the EPG information (S340). The EPG information is included in a broadcast signal received through the broadcast receiving unit 110. The signal separation unit 120 separates the EPG information from the received broadcast signal, and transmits the EPG information to the control unit 180. The EPG information may be received from the internet through the network interface 170.

The TV updates the EPG information stored in the TV based on the received EPG information (S350). The TV stores the updated EPG information in the storage unit 160 (S360).

If the EPG is completely updated, the TV is changed to the standby state (S370).

In doing so, the TV may update EPG information even while the TV is not operating, that is, when a user is not viewing the TV.

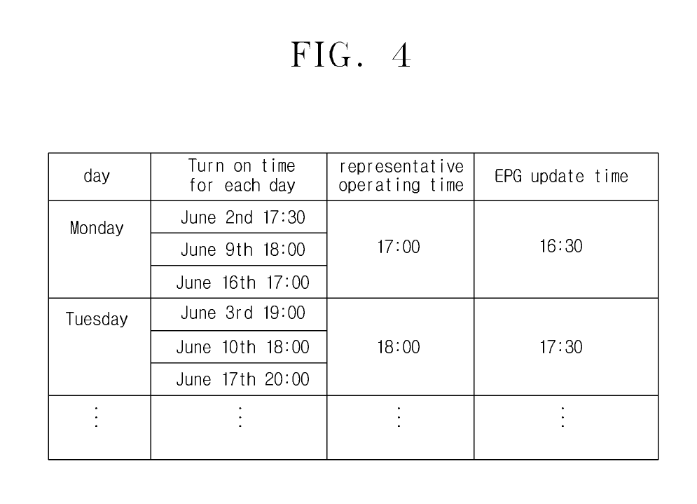

FIG. 4 is a table showing the time determined to update an EPG by setting the earliest turn-on time to be a representative operating time according to an exemplary embodiment of the present invention.

Referring to FIG. 4, the representative operating time of the TV is determined to be the earliest time among the turn-on times for each respective day. That is, the representative operating time for Monday is determined to be 17:00, and the representative operating time for Tuesday is determined to be 18:00. The times to update an EPG are determined to be and 17:30 which are thirty minutes earlier than the respective representative operating times.

As the time to update an EPG is determined to be earlier than the time at which the TV is turned on, the EPG may be updated even while a user is not viewing the TV.

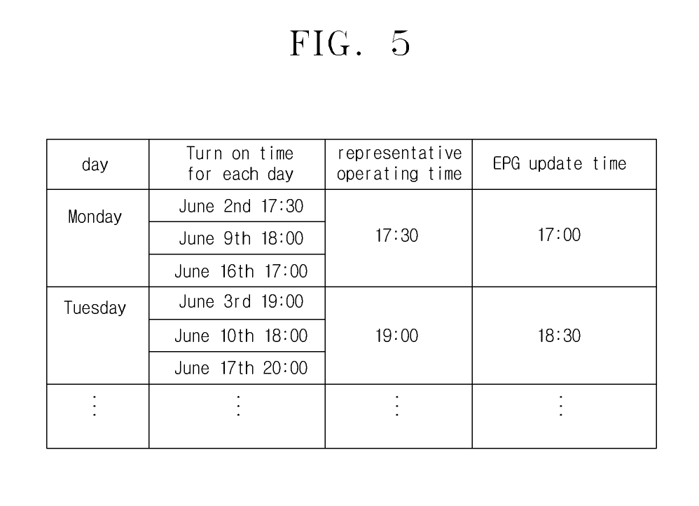

FIG. 5 is a table showing the time determined to update an EPG by setting the average turn-on time to be a representative operating time according to another exemplary embodiment of the present invention.

Referring to FIG. 5, the representative operating time of the TV is determined to be the average time of the turn-on times for each respective day. For example, the representative operating time for Monday is determined to be 17:30, and the representative operating time for Tuesday is determined to be 19:00. The times to update an EPG are determined to be 17:00 and 18:30 which are thirty minutes earlier than the respective representative operating times.

The time to update an EPG may be determined using the average time of the turn-on times for each respective day.

According to an exemplary embodiment of the present invention, while the EPG information is updated, other information may also be updated. For example, the present invention may be applied when various data stored in the TV are updated.

According to an exemplary embodiment of the present invention, the time to update an EPG is determined for each respective day, but the time to update an EPG may be determined using another basis. For example, the time to update an EPG may be determined for each respective day of a month, for example, the 1st, 2nd, . . . , 31st. The time to update an EPG may also be determined to be a predetermined time irrespective of the date or day.

In this exemplary embodiment of the present invention, while the TV is provided as a broadcast receiving apparatus, other broadcast receiving apparatuses may also be applied to an exemplary embodiment of the present invention. The broadcast receiving apparatus may be a setup box, a Digital Multimedia Broadcasting (DMB) receiver, or an Internet Protocol Television (IPTV) receiver.

Various exemplary embodiments of the present invention provide a method for updating an EPG, in which the time to update an EPG is determined, and a broadcast receiving apparatus using the operating information of the broadcast receiving apparatus. Accordingly, the EPG information is updated when a user is not viewing the broadcast receiving apparatus, and thus the user can use the EPG information without waiting for the EPG to be updated.

The user may check the newest EPG information through the broadcast receiving apparatus without performing additional manipulation to update the EPG information, since the broadcast receiving apparatus updates the EPG information at the time determined depending on operating information.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method for updating an electronic programming guide (EPG) of a broadcast receiving apparatus, the method comprising:
setting a time point within a time period while the broadcast receiving apparatus is not operating to be a start update time to start updating the EPG; and
updating EPG information at the start update time.

2. The method of claim 1, wherein the setting comprises:
storing operating information of the broadcast receiving apparatus; and
determining a time period during which the broadcast receiving apparatus does not operate based on the stored operating information.

3. The method of claim 2, wherein the setting further comprises:
calculating a representative operating time of the broadcast receiving apparatus based on the stored operating information; and
setting the start update time at a predetermined time interval earlier than the representative operating time.

4. The method of claim 3, wherein the calculating comprises:
extracting first turn-on times for one day and second turn-on times for another day from the stored operating information;
determining an earliest time of the first turn-on times and an earliest time of the second turn-on times; and
setting the determined earliest times of the first and the second turn-on times to be the representative operating times for respectively the one day and the another day.

5. The method of claim 3, wherein the calculating comprises:
extracting first turn-on times for one day and second turn-on times for another day from the stored operating information;
determining a first average turn-on time for the first turn-on times and a second average turn-on time for the second turn-on times; and
setting the determined first average turn-on time and the determined second average turn-on time to be the representative operating times for respectively the one and the another days.

6. The method of claim 3, wherein the predetermined time interval is longer than the time period required to update the EPG information.

7. The method of claim 2, wherein the operating information comprises turn-on times of the broadcast receiving apparatus.

8. The method of claim 1, wherein the updating comprises:
updating the EPG information after the broadcast receiving apparatus is turned on, if a current time corresponds to the start update time, and if the broadcast receiving apparatus is in a standby state.

9. The method of claim 8, wherein the updating further comprises:
changing the broadcast receiving apparatus to the standby state after the EPG information is updated.

10. The method of claim 1, wherein the updating comprises:
setting the start update time by a user; and
updating the EPG information at the start update time set by the user.

11. The method of claim 1, wherein the time period during which the broadcast receiving apparatus does not operate comprises a time period during which the broadcast receiving apparatus is in a standby state.

12. A broadcast receiving apparatus, comprising:
a storage unit which stores electronic programming guide (EPG) information; and
a control unit which sets a time point within a time period when the broadcast receiving apparatus is not operating to be a start update time to start updating an EPG, and starts updating the EPG information at the start update time.

13. The apparatus of claim 12, wherein the storage unit stores operating information of the broadcast receiving apparatus; and the control unit sets the time period, during which the broadcast receiving apparatus is not operating, based on the stored operating information.

14. The apparatus of claim 13, wherein the control unit calculates a representative operating time of the broadcast receiving apparatus based on the stored operating information, and sets the start update time at a predetermined time interval earlier than the representative operating time.

15. The apparatus of claim 14, wherein the control unit extracts first turn-on times for one day and second turn-on times for another day from the stored operating information, determines an earliest time of the first turn-on times and an earliest time of the second turn-on times, and sets the determined earliest times of the first and second turn-on times to be the representative operating times for respectively the one and the another days.

16. The apparatus of claim 14, wherein the control unit extracts first turn-on times for one day and second turn-on times for another day from the stored operating information, determines a first average turn-on time for the first turn-on times and a second average turn-on time for the second turn-on times, and sets the determined first average turn-on time and the determined second average turn-on time to be the representative operating times for respectively the one day and the another day.

17. The apparatus of claim 14, wherein the predetermined time interval is longer than a time period required to update the EPG information.

18. The apparatus of claim 13, wherein the operating information comprises turn-on times of the broadcast receiving apparatus.

19. The apparatus of claim 12, wherein if a current time corresponds to the start update time, and if the broadcast receiving apparatus is in a standby state, the control unit turns on the broadcast receiving apparatus, and updates the EPG information.

20. The apparatus of claim 19, wherein the control unit changes the broadcast receiving apparatus to the standby state after the EPG information is updated.

21. The apparatus of claim 12, wherein if a user sets the start update time, the control unit starts updating the EPG information at the start update time set by the user.

22. The apparatus of claim 12, wherein the time period during which the broadcast receiving apparatus does not operate comprises a time period during which the broadcast receiving apparatus is in a standby state.

23. A method for updating data stored in a broadcast receiving apparatus, comprising:
storing operating information of the broadcast receiving apparatus;
setting an update time based on the stored operating information; and
updating the stored data at the set update time.

24. A broadcast receiving apparatus, comprising:
a storage unit which stores operating information and predetermined data of the broadcast receiving apparatus; and
a control unit which sets an update time to update the stored predetermined data based on the operating information, and updates the stored predetermined data at the update time.
